(19) United States
(12) Patent Application Publication
(10) Pub. No.: US 2016/0044951 A1
(43) Pub. Date: Feb. 18, 2016

(54) Juice Extractor

(71) Applicant: Focus Products Group International, LLC, Lincolnshire, IL (US)

(72) Inventors: William A. Bucklew, Wilmette, IL (US); Zhe Shen, Palatine, IL (US)

(21) Appl. No.: 14/457,474

(22) Filed: Aug. 12, 2014

(51) Int. Cl. A23N 1/00; A23L 2/06

(52) U.S. Cl. CPC A23N 1/003; A23L 2/06; A23V 2002/00

(57) ABSTRACT

A juice extractor has a fruit receiving cavity having a center axis with first and second cavity portions movable along the center axis between an open position in which the first and second cavity portions are spaced away from each other a distance sufficient to allow a fruit to be inserted therein and a compressed position in which the first and second cavity portions are brought toward each other to compress the fruit. The first cavity portion has a press with a center recess. The second cavity portion has a bowl. The first and second cavity portions have cooperating geometry that allows the first and second cavity portions to be brought toward each other to the compressed position. The fruit receiving cavity has a blade support with cutting blades exposed therefrom. The cutting blades are positioned about the center axis and define planes parallel to the center axis.

### BACKGROUND AND SUMMARY

The disclosure is directed to a juice extractor. In particular, the juice extractor extracts juice from fruits, such as citrus fruits and the like. The juice extractor is configured to allow a whole fruit to be inserted in the extractor so as obviate the need to slice the fruit in half before inserting it in the extractor.

### BRIEF DESCRIPTION OF THE DRAWINGS

FIG. 1 is an isometric view of the juice extractor.

FIG. 2 is a front elevational view of the juice extractor of FIG. 1.

FIG. 3 is a right side view of the juice extractor of FIG. 2.

FIG. 4 is a left side view of the juice extractor of FIG. 2.

FIG. 5 is a rear elevational view of the juice extractor of FIG. 2.

FIG. 6 is a top view of the juice extractor of FIG. 2.

FIG. 7 is a bottom view of the juice extractor of FIG. 2.

FIG. 8 is an exploded view of the fruit receiving cavity and the support portions of the juice extractor of FIG. 1.

FIG. 9 is a cross-sectional view of the components of FIG. 8.

FIG. 10 is an isometric view of a juicer blade associated with the juice extractor of FIG. 1.

FIG. 11 is a side elevational view of the juicer blade of the juice extractor of FIG. 1.

FIG. 12 is a cross-sectional view of the fruit receiving cavity and support structure with a top cavity portion spaced away from a bottom cavity portion to show further details of the fruit receiving cavity components.

FIG. 13 is a cross-sectional view of the fruit receiving cavity with the top cavity portion in register with the bottom cavity portion.

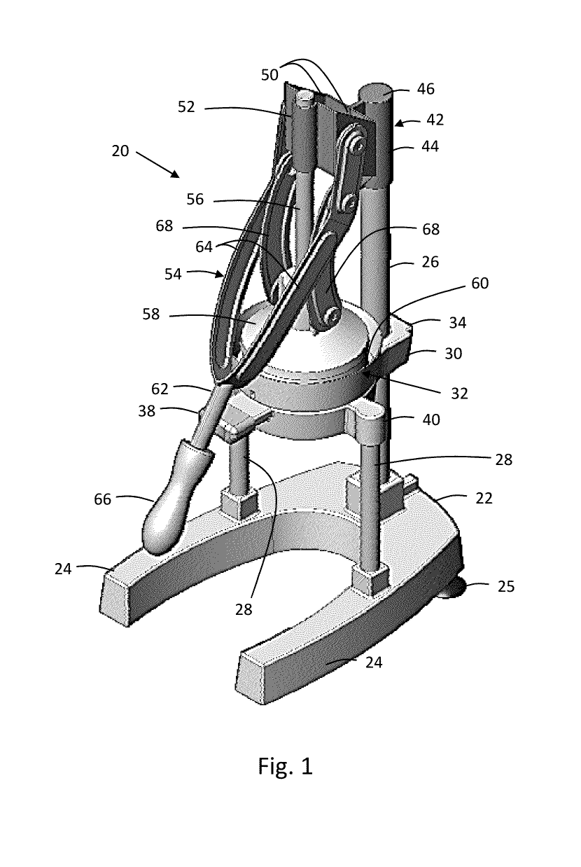

### DETAILED DESCRIPTION

The juice extractor 20 comprises a base 22 having a general horseshoe type shape with legs 24. The base 22 may have suction cups 25 for instance on the bottom of the legs 24 to assist in fixing the base to a counter top or other support. One is shown and others may be provided around the base as necessary. The base 22 has a center pillar 26 extending therefrom in a central part of the base and posts 28 on each leg of the base. A fruit cavity support 30 is positioned above the base 22 on top of the posts 28. The fruit cavity support 30 provides a rigid mount for a fruit receiving cavity 32. The fruit to be processed is insertable into the fruit receiving cavity 32 and compressed therein. Juice extracted from the processed fruit flows from the cavity 32 through the fruit cavity support 30 to a serving dispenser (not shown) that may be positioned under the fruit cavity support and between the legs 24 of the horse shoe base. The fruit cavity support 30 has a rear lobe extension 34 with a hole that allows the central pillar 26 to pass therethrough. The fruit cavity support 34 may be fixed in position relative to the central pillar 26 with a set screw 36 passing through the rear lobe extension 34 and engaging the central pillar. The posts 28 projecting upward from each leg 24 of the base 22 provide additional support for the fruit cavity support 30. The fruit cavity support 30 may be provided with a handle 38 on its front end diametrically opposite the rear lobe extension 34. The fruit cavity support 30 may have two cap-like protrusions 40 diametrically spaced apart on lateral sides of the fruit cavity support. The cap-like protrusions 40 have hollow interior portions that are dimensioned to have a tight press fit with the posts 28. The cap-like protrusions 40 may receive the distal ends of the posts 28 thereby allowing the fruit cavity support 30 to be supported above the base in a rigid configuration. Set screws (not shown) may be provided through the cap-like protrusions to engage the distal ends of the posts for additional support. As shown in the drawings, the cap-like protrusions 40 are positioned 90 degrees apart from the rear lobe extension 34.

On a distal end of the central pillar 26, a lever arm support 42 may be provided. The lever arm support 42 may have a sleeve 44 which is configured to receive the distal end of the central pillar 26. The sleeve 44 may have a cap 46 that seals the interior of the sleeve and allows the lever arm support 42 to be rigidly mounted to the central pillar 26. A set screw 48 passing through the sleeve 44 may prevent rotation of the lever arm support about the central pillar. The set screw 48 may be provided on surface of the sleeve 44 at the rear of the extractor. Extending from the sleeve 44 toward the front of the extractor, the lever arm support 42 may have bifurcated support arms 50 and a bushing portion 52 extending there between. The bifurcated support arms 50 provide a mounting surface for a lever arm and crank assembly 54 of the extractor. The bushing portion 52 of the lever arm support provides a bearing surface for reciprocal sliding motion of a center plunger 56.

The fruit receiving cavity 32 may be formed by a top cavity portion 58 and a bottom cavity portion 60. The fruit to be processed may be inserted between the top cavity portion 58 and the bottom cavity portion 60 and compressed therebetween. The bottom cavity portion 60 may be fixed in positioned and operatively supported by the fruit cavity support 30. The top cavity portion 58 is connected with the center plunger 56 and movable in a vertical direction as shown in the drawings as the center plunger reciprocatingly slides in the bushing portion 52 of the lever arm support 42 by action of the lever arm and crank assembly 54.

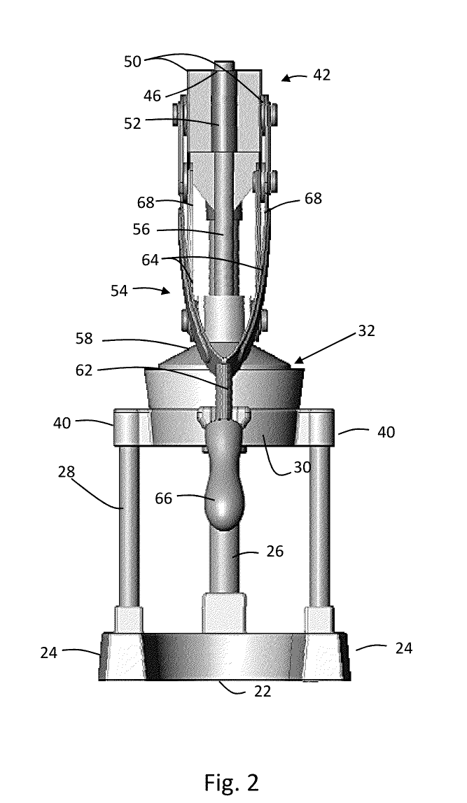

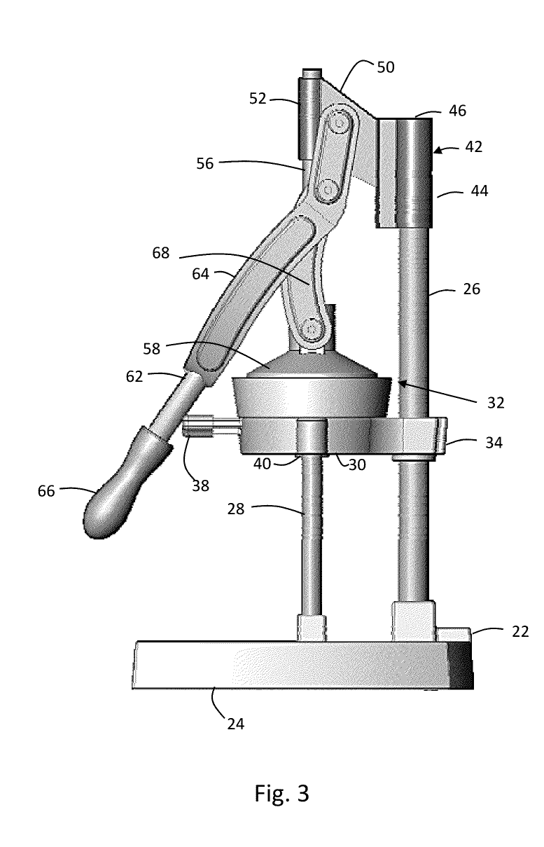

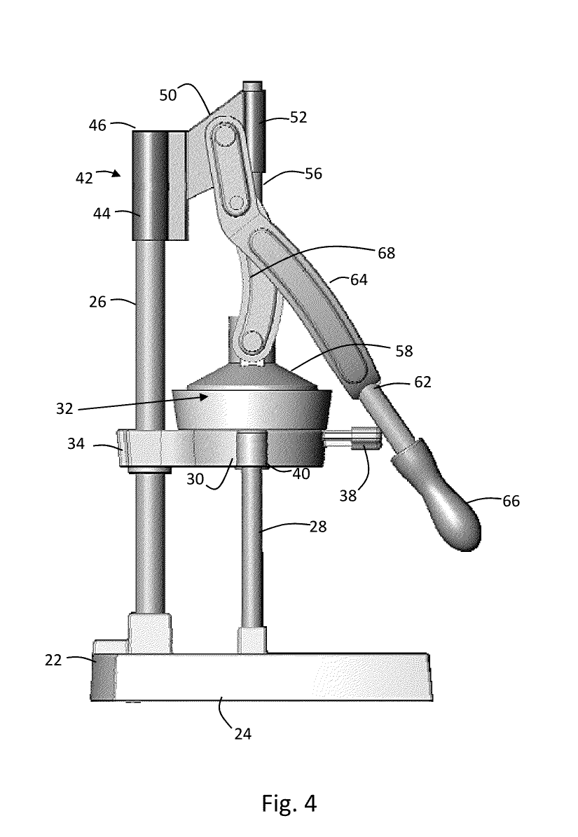

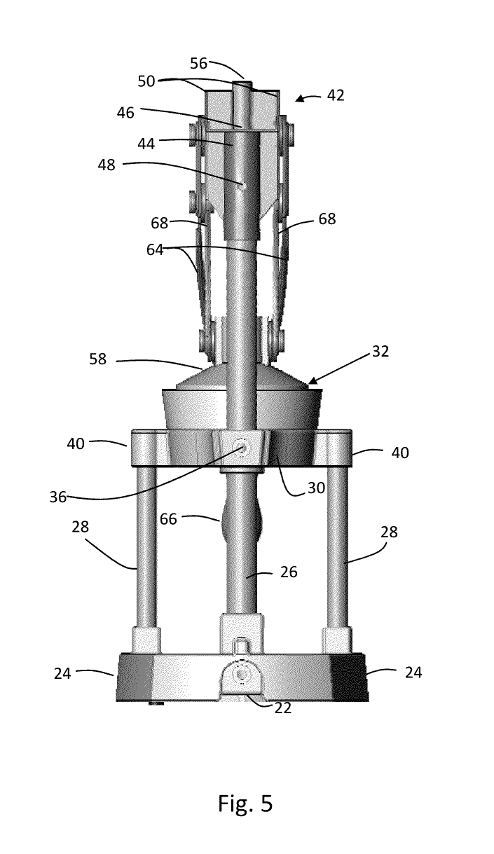

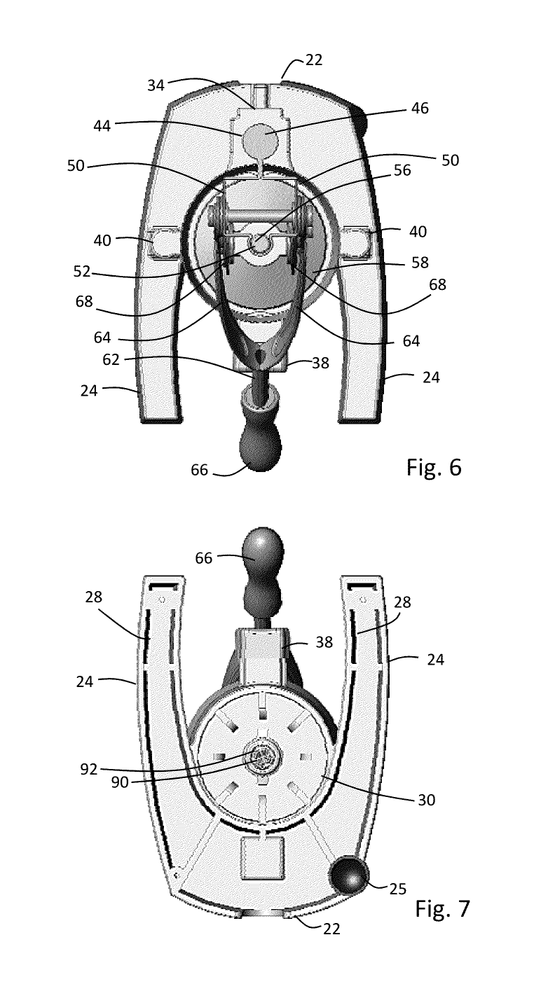

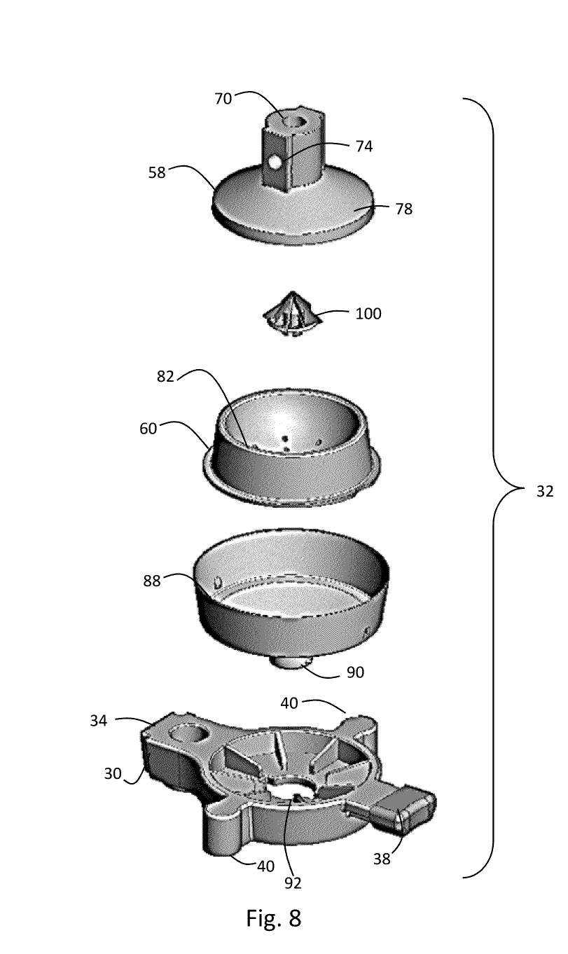

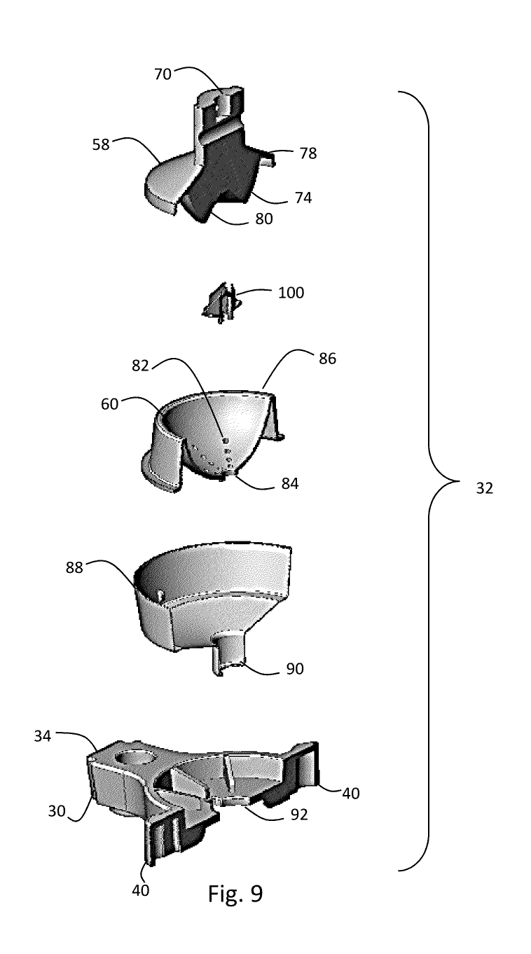

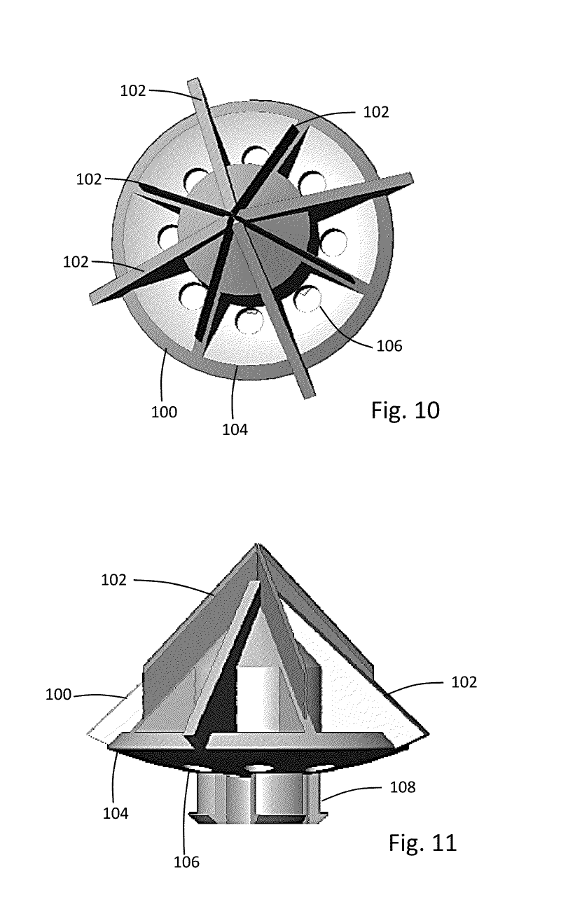

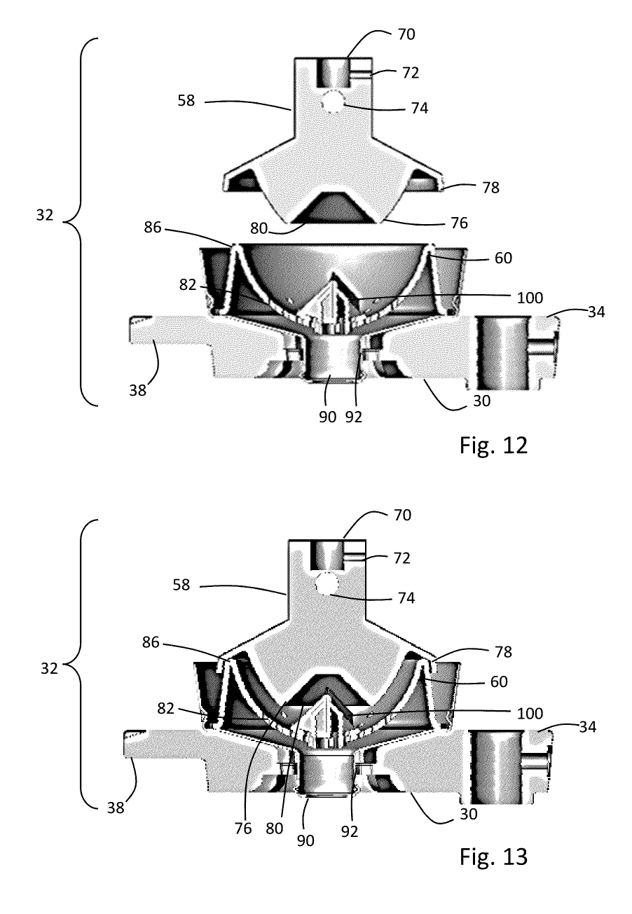

The lever arm and crank assembly 54 includes a lever arm 62 with bifurcations on one end 64 and a handle portion 66 on an opposite end. Each lever arm bifurcation 64 may have its distal end pivotally connected to a respective bifurcation 50 of the lever arm support 42 and an intermediate portion pivotally connected to a crank arm 68. The crank arm 68 is in turn pivotally connected with the top cavity portion 58 opposite its pivot connection with the intermediate portion of the bifurcation 64 of the lever arm 62. As shown in the drawings, two crank arms 68 are provided for each bifurcation 64 of the lever arm 62. One crank arm may also be provided instead of two crank arms as shown. As shown in FIGS. 2 through 7, the lever arm 62 is in a downward position which allows for positioning of the top cavity portion 58 in a downward orientation in register with the bottom cavity portion 60. Upward pivoting motion of the lever arm 62 causes upward rotation of the crank arms 68 which translates into linear (i.e., vertical) motion of the top cavity portion 58 as the center plunger 56 slides through the lever arm support bushing 52. In other words, upward motion of the lever arm 62 creates a space between the top cavity portion 58 and the bottom cavity portion 60 to allow a fruit to be processed to be inserted in the fruit receiving cavity 32. The bottom cavity portion may also be made movable relative to the top cavity portion. The handle portion 66 of the lever arm 62 may facilitate operation of the juice extractor.

The top cavity portion 58 has a general bell shape with a narrow top and wide bottom. A recess 70 may be formed in a top of the top cavity portion 58 which receives a proximal end of the center plunger 56. The center plunger 56 may be held in position in the recess 70 of the top cavity portion with a set screw directed through a set screw hole 72 in the top cavity portion. The crank arms 68 may be connected to the top of the top cavity portion 58 with a one or more mechanical fasteners directed through a crank arm mounting hole 74 formed in the top cavity portion. The mechanical fastener(s) provide(s) the pivot connection of the crank arms 68 with the top cavity portion 58. The bottom of the top cavity portion comprises a ram 76, which may have a conical shape, projecting from a center of the bottom of the top cavity portion, and a rim 78 extending around the periphery of the bottom surrounding the ram. The rim 78 may extend around the ram 76 to limit juice from splashing out of the fruit receiving cavity 32 during extraction. The ram 76 may include a concave recess 80. The concave recess may 80 be shaped in accordance with the shape of the fruit to be processed in the juice extractor. The top cavity portion may be disassemblable from the center plunger to allow cleaning and to allow interchangeability among top cavity portions depending upon the fruit to be processed. For instance, interchangeability may allow for the user to use one top cavity portion with a specifically dimensioned/shaped ram for an orange and another top cavity portion with a differently/shaped ram for a lemon or lime, etc. The ram may also be removably attachable to the top cavity portion for such as purpose.

The bottom cavity portion 60 generally has a bowl shape sized to accommodate the fruit to be processed. The bottom cavity portion 60 has a plurality of perforations 82 that allow juice to flow from the cavity. The bottom cavity portion 60 may have a central opening 84 with the perforations surrounding the central opening. An upper and outer periphery 86 of the bottom cavity bowl shape may fit within the rim 78 of the top cavity portion 58 when the top cavity portion and bottom cavity portion 60 are brought into register. The bottom cavity portion may also allow for interchangeability to allow the user to use one bottom cavity portion with a specifically dimensioned/shaped bowl for an orange and another bottom cavity portion with a differently/shaped bowl for a lemon or lime, etc.

In the drawings, a juice flow base portion 88 is shown as a separate piece that surrounds the bottom cavity portion 60 and is supported by the fruit cavity support 30. The juice flow base portion 88 may be integral and/or monolithic with the bottom cavity portion 60 and/or fruit cavity support 30. The juice flow base portion 88 has an interior volume which is shaped to accommodate the bottom cavity portion. The juice flow base portion 88 generally comprises a funnel shaped member with a spout portion 90 extending from a bottom center of the juice flow base. The spout portion 90 may project through a central aperture 92 in the fruit cavity support 30 and direct extracted juice to a serving dispenser (not shown) positioned below the fruit cavity support. The perforations 82 in the bottom of the bottom cavity portion 60 allow the bottom cavity portion to be in communication with the juice flow base portion 88. The juice that is extracted from the fruit during processing flows through the perforations 82 in the bottom cavity portion 60 into the juice flow base portion 88 and through the spout 90 portion of the juice flow base portion to a serving dispenser located under the fruit cavity support 30. The spout portion 90 of the juice flow base portion 88 may be releasably connected to the fruit cavity support 30 to allow disassembly for cleaning.

A blade support 100 may be centrally located in the bottom cavity portion 60. The blade support 100 may comprise a plurality of triangular projections 102 extending from a generally circular base 104. One or more of the triangular projections may have a cutting surface. The cutting surfaces may have a staggered height. The circular base 104 may have perforations 106 that communicate with the perforations 82 in the bottom cavity portion 80 thereby allowing juice to flow from the blade support 100 through the bottom cavity portion and through the juice flow base portion to a serving dispenser. The blade support 100 may be releasably attached to the bottom cavity portion 60 and extend upward into the concave recess 80 of the top cavity portion 58 when the top cavity portion and bottom cavity portion are in register. The blade support may also be integral or monolithic with the bottom cavity portion. As shown in the drawings, the blade support 100 is mounted and extends upward from the bottom cavity portion central opening 84. The blade support 100 may have deflectable tabs 108 extending radially from the circular base 104 that engage the bottom cavity central opening 84 in releasably attaching the blade from the bottom cavity portion 60.

In operation, a whole (e.g., unsliced) citrus fruit may be inserted into the fruit receiving cavity 32 formed by the spaced apart relationship of the top cavity portion 58 and the bottom cavity portion 60. The lever arm 62 may rotated to the upward position to draw the top cavity portion 58 away from the bottom cavity portion 60 to an open position to open the fruit receiving cavity 32. Fruit may be inserted in the fruit receiving cavity 32 and fixed in position by puncturing the fruit with the blade support 100. The blade support 100 may assist in fixing the fruit in position in the open cavity prior to compression. The fruit may be positioned in the fruit receiving cavity 32 with a core of the fruit coaxially aligned with a center axis of the fruit receiving cavity such that axial ends of the fruit are aligned with a center recess of a press of the top cavity portion 58 and a center of a bowl of the bottom cavity portion 60. With the fruit disposed in the fruit receiving cavity 32, the lever arm 62 may be actuated to drive the top cavity portion 58 downward toward the bottom cavity portion to a compressed position, thereby compressing the fruit between the top cavity portion 58 and the bottom cavity portion 60. The blade support 100 may further puncture the fruit as the top cavity portion 58 is driven toward the bottom cavity portion 60. Because of the blade portions 102 formed on the blade support 100, the blade portions 102 may be driven into the fruit adjacent the core. The slicing action of the blade portions 102 extracts juice and allows the fruit to collapse around the blade support 100. The collapsing of the fruit allows the top and bottom cavity portions 58,60 to compress the fruit and maximize the extraction of juice from the fruit. The ram 78 and center recess 88 of the top cavity portion 58 maximizes the compression of the fruit against the bottom cavity portion 60. The center recess 80 of the ram 78 forces a central portion of the citrus fruit against the blade support 100 and against the bottom cavity portion 60 while the radially outer portions of the ram compress the outer radial portion of the fruit. The outer radial portions of the fruit are deformed and compressed along the outer surfaces the ram 76. A conical shape for the ram 78 may assist in deforming and compressing the fruit. Because the fruit is punctured first as the blade support 100 is driven into the fruit, the ram 76 is able to compress the fruit further which allows juice to be more fully extracted from the fruit, and allows juice to be extracted from fruit without having to first slice the citrus fruit in half.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A juice extractor comprising a fruit receiving cavity configured to receive a fruit for processing therein, the fruit receiving cavity having a center axis with first and second cavity portions movable along the center axis between an open position in which the first and second cavity portions are spaced away from each other a distance sufficient to allow a fruit to be inserted in the fruit receiving cavity and a compressed position in which the first and second cavity portions are brought toward each other to compress the fruit, the first cavity portion comprising a ram with a center recess, the second cavity portion comprising a bowl, the first and second cavity portions having cooperating geometry that allows the first and second cavity portions to be brought toward each other in the compressed position, the fruit receiving cavity having a blade support with cutting blade portions exposed therefrom, the cutting blade portions being positioned about the center axis and defining planes parallel to the center axis.

2. The juice extractor of claim 1, wherein the first cavity portion is moved relative to the second cavity portion along the center axis between the open position and the compressed position.

3. The juice extractor of claim 1, wherein the blade support is disposed in the second cavity portion.

4. The juice extractor of claim 3, wherein the blade support is releasably connected to the second cavity portion.

5. The juice extractor of claim 1 wherein the second cavity portion has perforations configured for juice flow.

6. The juice extractor of claim 1, wherein the second cavity portion bowl has an outer peripheral rim that surrounds the first cavity portion rim in the compressed position.

7. The juice extractor of claim 1, wherein the first cavity portion press has a conical shape.

8. The juice extractor of claim 1, wherein the first cavity portion has a cover radially outward of the press that surrounds the second cavity portion in the compressed position.

9. A juice extractor comprising a fruit receiving cavity configured to receive a fruit for processing therein, the fruit receiving cavity having a center axis with first and second cavity portions movable along the center axis between an open position in which the first and second cavity portions are spaced away from each other a distance sufficient to allow a fruit to be inserted in the fruit receiving cavity and a compressed position in which the first and second cavity portions are brought toward each other to compress the fruit, the first cavity portion comprising a press with a center recess, the second cavity portion comprising a bowl with blades therein, the first cavity portion press center recess being dimensioned to allow receive a portion of the blades therein when the first and second cavity portions are to the compressed position, the cutting blades extending from a blade support in the second cavity portion, the cutting blades being positioned about the center axis and defining planes parallel to the center axis.

10. The juice extractor of claim 9, wherein the first cavity portion is moved relative to the second cavity portion along the center axis between the open position and the compressed position.

11. The juice extractor of claim 9, wherein the blade support is releasably connected to the second cavity portion.

12. The juice extractor of claim 9, wherein the second cavity portion has perforations configured for juice flow.

13. The juice extractor of claim 9, wherein the second cavity portion bowl has an outer peripheral rim that surrounds the first cavity portion rim in the compressed position.

14. The juice extractor of claim 9, wherein the first cavity portion press has a conical shape.

15. The juice extractor of claim 9, wherein the first cavity portion has a cover radially outward of the press that surrounds the second cavity portion in the compressed position.

16. A method of extracting juice from an unsliced fruit by compressing the unsliced fruit in a fruit receiving cavity, the method comprising:
moving first and second cavity portions of the fruit receiving cavity away from each other along a center axis of the fruit receiving cavity a distance sufficient to allow the unsliced fruit to be inserted in the fruit receiving cavity;
inserting the unsliced fruit in the fruit receiving cavity between the first and second cavity portions;
positioning the fruit in the fruit receiving cavity with a core of the fruit coaxially aligned with the center axis of the fruit receiving cavity such that axial ends of the fruit are aligned with a center recess of a press of the first cavity portion and a center of a bowl of the second cavity portion;
mounting the unsliced fruit in the fruit receiving cavity upon a blade positioned in the fruit receiving cavity; and
moving the first and second cavity portions toward each other along the center axis to compress the fruit and extract the juice from the fruit.

17. The method of claim 16 wherein the step of moving the first and second cavity portions toward each other includes moving the first cavity portion relative to the second cavity portion.

18. The method of claim 16 wherein the step of mounting the unsliced fruit in the fruit receiving cavity upon a blade positioned in the fruit receiving cavity includes puncturing the fruit.

19. The method of claim 16 wherein the step of moving first and second cavity portions of the fruit receiving cavity away from each other along a center axis of the fruit receiving cavity a distance sufficient to allow the unsliced fruit to be inserted in the fruit receiving cavity includes moving the first cavity portion relative to the second cavity portion.

20. The method of claim 16 further comprising selecting at least one of a whole orange, a whole lemon, and a whole lime as the fruit to extract the juice therefrom.
